(19) United States
(12) Patent Application Publication
(10) Pub. No.: US 2007/0283191 A1
(43) Pub. Date: Dec. 6, 2007

(54) Integrated Circuit with Debug Support Interface

(76) Inventors: Klaus Dieter McDonald-Maier, Kent (GB); Andrew Brian Thomas Hopkins, Kent (GB)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/583,495

(22) PCT Filed: Nov. 29, 2004
(86) PCT No.: PCT/GB04/05014

§ 371 Date: Jun. 22, 2007

(30) Foreign Application Priority Data
Dec. 19, 2003 (GB) 0329516.9

(51) Int. Cl. G06F 11/16

(52) U.S. Cl. 714/39

(57) ABSTRACT

A high speed debug support interface has circuits to interface on-chip debug support circuits to a high bandwidth communications port means located on the surface of a system integrated circuit (101) and to on-chip debug support circuits (100). The communication port means can be realised by bonding or integrating special sender and or receiver cells preferably optical sender cells (103) and or optical receiver cells (110) onto the surface of the system integrated circuit (101). The high speed debug support interface communicates with on-chip or in-assembly debug support circuits and an external development tool (108) to permit hardware and software related debugging and development activities, including program tracing, data tracing and memory substitution. The high speed debug support interface has circuits to interface on-chip debug support circuits to system resources such as memory located within the device assembly (102) and connected by the system interconnect.

### FIELD OF THE INVENTION

This invention relates to an integrated circuit assembly with a debug support interface.

### BACKGROUND OF THE INVENTION

A debug support interface is an interface for communicating data for development purposes from an integrated circuit containing configurable circuits to an external development tool. The debug support interface is intended primarily for development, testing and related purposes, and is not typically intended for use in the final product. However, resources used by the debug support development interface may be shared with components of the system and actively used within the system as marketed. An example of resource sharing is device connections for input and or output of data which are useable as general purpose digital connections or as trace port pins.

The configurable circuits which are monitored by the debug interface are typically digital circuits, but may contain analogue circuits or parts. The debug interface assists in development of software, hardware or both software and hardware.

The need for debug functionality increases as the level of integration increases. With complete systems integrated into a single chip, the interfaces between components which used to be available to logic analysers are now on-chip and cannot be accessed directly using these analysis tools.

A debug interface is not simply a set of connections for transferring development data in and or out of a system, but it also contains circuits integrated with the system onto a chip to monitor the internal state of the system and make this state data available for use by an external development tool. These debug support circuits enable the system states to be monitored from within the chip package. For example, microprocessors are typically provided with debug support circuits, which are used to help debug software being developed and also identify hardware problems or limitations within the system. The debug support interface allows the on-chip debug support circuits to be configured by an external tool. System resources can also be read or written to.

The debug support interface including the debug circuits is configurable to enable selective tracing of the system's internal nodes. Tracing is where data is sent to either an on-chip buffer memory or directly to an external tool memory to allow a development tool to reconstruct operational history for the selected nodes. An example node that can be traced is the program counter of one or many microprocessors, microcontrollers, digital signal processors or similar which form part of the system. Other example nodes include read and or write accesses to data variables by the processor or other active module such as a direct memory access controller. The debug support circuits may capture these accesses at the master, the slave or at the interconnect. Tracing of digital values for circuits having high clock frequencies requires a high bandwidth.

Conventionally, a debug support interface comprises a trace port, to which this state data is provided, and the data is then stored externally. Both clock frequencies and the number of data sources are rapidly growing with increased integration, requiring more bandwidth than can be provided by traditional general purpose output connections. For example, a normal pin on a semiconductor package is limited in bandwidth to about 100 MHz. One solution to this bandwidth problem is to increase the number of external connections, thus increasing the interface bandwidth.

There is, however, a requirement for development parts to have the same package footprint as the mass produced production part. Adding more package pins therefore has the significant disadvantage that it uses more integrated circuit package pins on both the development and production parts and is prohibitively expensive in most cases.

There is therefore a need for a debug support interface which allows high speed data transfer but which also enables a chip to be used for development purposes to be substantially the same as a chip for manufacture, and with the packaging complexity of the chip being appropriate for the interface requirements of the mass production chip, and not increased by providing the debug interface.

### SUMMARY OF THE INVENTION

According to a first aspect of the invention, there is provided an integrated circuit assembly for use in a system, comprising:
a first arrangement of connection terminals for connecting the integrated circuit to other components of the system;
debug circuitry;
a debug interface comprising a second arrangement of connection terminals;
a signal conversion arrangement coupled to the second arrangement of connection terminals for converting electrical signals provided to the second arrangement of terminals into a format for transmission to external monitoring circuitry; and
a communications link for communicating the data provided to the second arrangement of terminals to the external monitoring circuitry.

In this arrangement, a dedicated set of connection terminals are used for providing debug information, and the data provided to these terminals is converted, preferably into a format which supports higher speed data transfer.

For example, the signal conversion arrangement can comprise electro-optical conversion means, and the communications link comprises an optical communications link. Thus, a high speed optical data link is provided for the debug information. The electro-optical conversion means may comprise an array of lasers, for example vertical cavity surface emitting lasers.

Alternatively, the signal conversion arrangement may comprise analogue electrical circuitry for implementing digital communication over the communications link.

Alternatively, the signal conversion arrangement may comprise analogue electrical circuitry for control and modulation of electro-optical conversion means mounted adjacent or in close proximity to the electrical circuitry.

The first arrangement of connection terminals can be provided as a ring of terminals around the periphery of an upper surface of the assembly, and the second arrangement of connection terminals can then be provided on the upper surface of the assembly within the ring. Connection to the inner second arrangement of terminals can be made by a flip chip bonding technique. The second arrangement of terminals are preferably formed from a top metal layer of the assembly.

Alternatively the combination of the first and second arrangements of connection terminals can be provided as a ring of terminals around the periphery of an upper surface of the assembly. Connection between the first arrangement of terminals and the device package can be made using a wire bonding technique. In applications where a bare integrated circuit assembly is mounted directly to the circuit board substrate, wire bonding is also suitable. Connection with the second arrangement of terminals can then also be made using a wire bonding technique. The second arrangement of terminals is preferably connected to an electro-optical conversion arrangement, but alternatively may be connected to a second integrated circuit assembly for electrical conversion of the signals to a form suitable for driving an electro-optical conversion arrangement.

The invention enables a single chip design to be used both for a mass produced version of the chip and for one or more debug versions of the chip. The invention thus provides a set of integrated circuits, comprising at least one first integrated circuit assembly of the invention having debug capability, and a plurality of second integrated circuit assemblies having the same design as the at least one first assembly in respect of the first arrangement of connection terminals and the debug interface, and wherein the plurality of second assemblies are not provided with the communications link of the at least one first assembly.

The mass production chips can have the debug circuitry, but the connection of the debug information to external monitoring arrangements is made with reduced functionality, such as when conventional connections are used. Although the mass production chips have the debug circuitry, this does not require an increased number of connections to be bonded from the mass production assembly as this is only done for the development part, so that the cost of providing the debug capability is kept to a minimum.

The invention also provides a method of performing a debug operation, using an integrated circuit assembly comprising a first arrangement of connection terminals, debug circuitry, and a debug interface comprising a second arrangement of connection terminals, the method comprising:
coupling a signal conversion arrangement to the second arrangement of connection terminals;
using the signal conversion arrangement to convert electrical signals provided to the second arrangement of terminals into a second format;
transmitting the signals using the second format to external monitoring circuitry; and
performing a debug operation using the external monitoring circuitry.

In this method, the signal conversion arrangement preferably comprises electro-optical conversion means and any necessary driver circuits.

The high speed debug support interface of the invention includes conversion circuits to take advantage of existing high speed connection technology, which can offer bandwidth over one magnitude greater per bit than conventional connections. Increased bandwidth permits the debugging and development of complex systems on-chip and systems in-package with one or many processor cores and active peripherals. Additionally the high speed debug support interface allows advanced development activities including memory substitution and rapid prototyping.

Memory substitution is a development technique where memory access requests from part of the system are redirected to the high speed debug support interface which then makes the access request to external memory devices provided as part of the development tool or to an alternative memory location on-chip or in-package. Memory substitution supports the calibration development activity without dedicated on-chip or in-package memories. One extension of memory substitution is memory shadowing, in which data write accesses to a region in memory are made in parallel to the high speed debug support interface. This then stores written data using internal or external memory independently to create a copy of the region in memory which can be viewed using the development tool when memory shadowing has been disabled.

On-chip debug support circuits may require a driving clock that differs from the system clocks; and this can optionally be provided via the high speed debug support interface and external port to avoid using on-chip resources. The high speed debug support interface has on-chip debug support circuits providing the facility to access on-chip resources such as memory and registers. When used as part of a mass produced system in a packaged device containing multiple integrated circuits, the debug support circuits contained in one or many integrated circuits can access resources such as memory and registers in the other circuits forming part of the system in package device.

According to a second aspect of the invention, there is provided an integrated circuit assembly for use in a system, comprising:
a first integrated circuit, comprising:
   a first arrangement of connection terminals for connecting the integrated circuit to other components of the system, debug circuitry and a debug interface comprising a second arrangement of connection terminals; and
   a second integrated circuit memory device, comprising a third arrangement of connection terminals connected to the first or second arrangement of connection terminals of the first integrated circuit,
wherein the debug interface provides access to internal operation information of the first and second integrated circuits.

Specific embodiments of the invention will now be described by way of example with reference to the accompanying drawings in which:

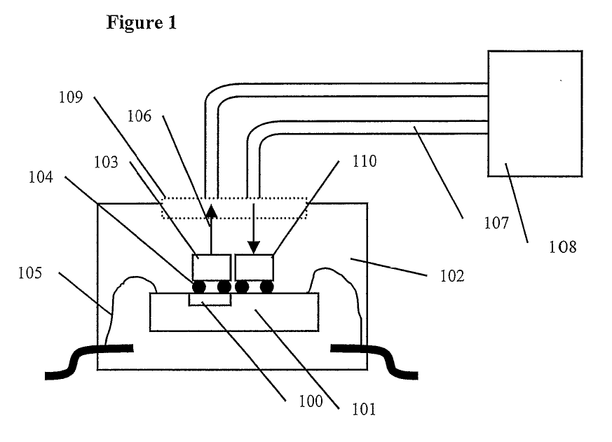

FIG. 1 illustrates the high speed debug support interface with optical sender and receiver based connections bonded onto the chip.

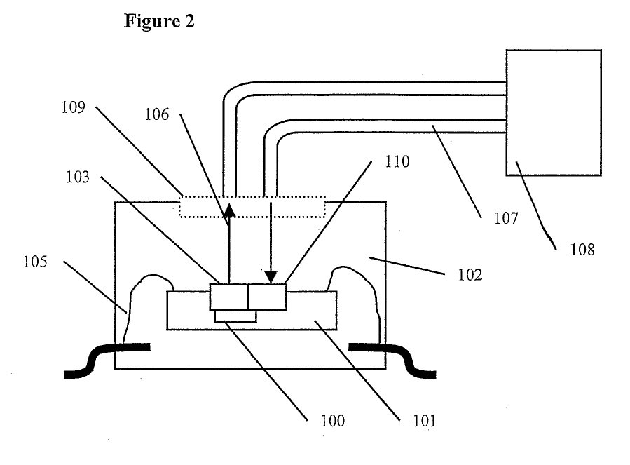

FIG. 2 illustrates the high speed debug support interface with integrated optical sender and receiver based connections.

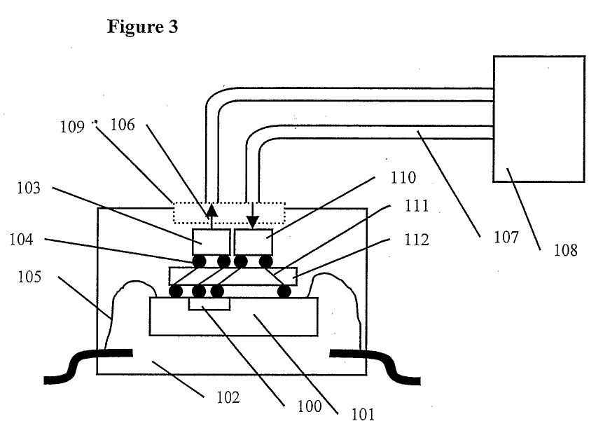

FIG. 3 illustrates the high speed debug support interface with translation mask.

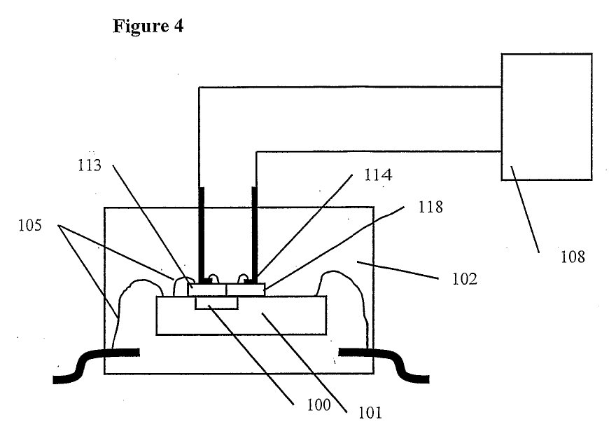

FIG. 4 illustrates the high speed debug support interface with electrical driver cells bonded onto the chip.

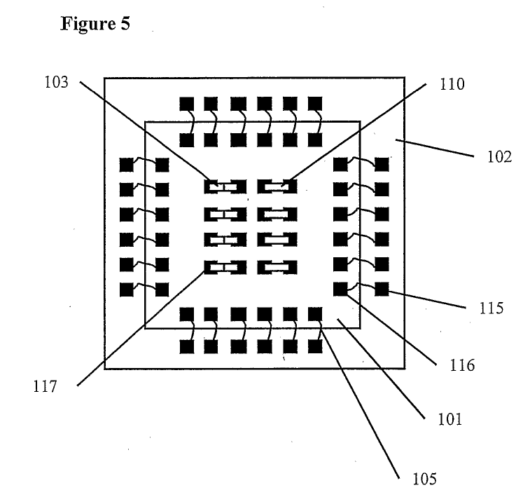

FIG. 5 illustrates the inside of a device package containing the high speed debug support interface.

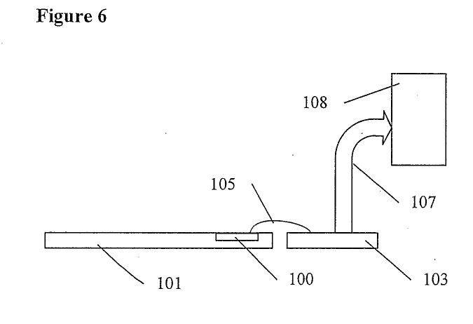

FIG. 6 illustrates the high speed interface with optical senders wire bonded to the adjacent first integrated circuit.

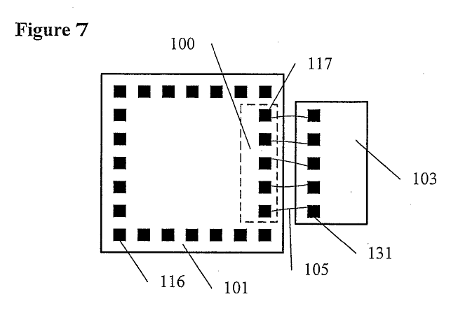

FIG. 7 illustrates in plan view a high speed interface with optical senders wire bonded to the adjacent first integrated circuit where the first and second arrangements of connection terminals are combined to form a using around the periphery of the first integrated circuit.

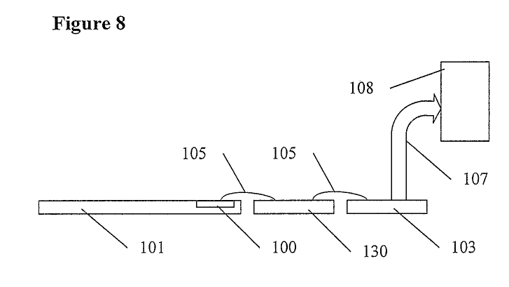

FIG. 8 illustrates the high speed interface connected to a second integrated circuit that contains further electrical conversion circuits for modulating the data signals and driving the optical senders.

### DETAILED DESCRIPTION

The invention provides an integrated circuit assembly in which a first arrangement of connection terminals is for connecting the integrated circuit to other components of the system. Debug circuitry is associated with a debug interface comprising a second arrangement of connection terminals. A signal conversion arrangement converts electrical signals provided to the second arrangement of terminals into a higher speed format for transmission to external monitoring circuitry, and this higher speed data is provided over a communications link.

Referring to the drawings, the high speed debug support interface comprises debug support circuits 100 integrated onto into a system integrated circuit 101 which is a semiconductor chip containing circuits providing the system functionality. In specific embodiments the circuit is formed within a package 102.

The high speed debug support interface connects to a bonding pad arrangement 117 shown in FIG. 5 and formed using the regular integration process on the top metal layer of the integrated circuit or using a bonding pad arrangement with protection form electrostatic discharge. This bonding pad arrangement 117 is used to enable the bonding of high speed sender and/or receiver cells to the package, thus forming a hybrid circuit.

As shown in FIG. 5, a first arrangement of connection terminals 105 for connecting the integrated circuit to other components of the system is provided around the periphery of the top surface of the package. These connect via wirebonding links 105 to pads 115 on an underlying circuit board. In the specific embodiment shown by FIG. 5, the second arrangement of connection terminals 117 of the debug interface are formed within the ring defined by the peripheral terminals 116. FIG. 7 shows an alternative embodiment where the first arrangement of connection terminals 116 for system use are combined with the second arrangement of connection terminals 117 for development use to form a ring of pads around the periphery of the system integrated circuit 101 combined with the debug support circuits 100.

In the preferred embodiments, the bonding pad arrangement 117 and the high speed debug support interface and debug support circuits 100 are present in all integrated circuits manufactured as part of a product family including high volume mass produced parts as well as lower volume parts used for development purposes.

The development components take fall advantage of the high speed debug support interface by bonding or integrating additional components or circuits to the standard mass produced version. Thus, the production device has the same behaviour as the development part. When a component is manufactured in very high volumes, it may be practical to omit some of the chip parts such as the bonding pads 117 on some mask sets.

A first embodiment is shown in FIG. 1 and FIG. 5. Optical sender cells 103 and optical receiver cells 110 are bonded onto the system integrated circuit 101 using a solder bump 104 bonding technique such as flip-chip bonding.

Thus, electro-optic conversion is provided at the debug support interface. This electro-optic conversion is provided only for the development components. In the mass production components, the arrangement of contact pads may be covered by a passivation layer.

The electro-optic conversion enables a higher bandwidth transmission link 107 to the external monitoring circuitry 108. For example, a number of electrical signals at the debug interface terminals 104 can be multiplexed together and provided over a shared optical fiber.

The optical sender cells 103 may be vertical cavity surface emitting lasers, and they may arranged in an array format. The array of lasers may be formed with the optical fiber connections as a sub-assembly, and this sub-assembly can then be flip chip bonded to the debug support interface.

Thus, a set of chips provided to a product developer will comprise a number of mass production chips, in which the arrangement of bonding pads is covered over. A number of development components will have the bonding pad arrangement exposed, and the chip developer will carry out the flip chip bonding to create the development version.

The monitoring arrangement 108 will of course be provided with opto-electric conversion capability in order to process the optical signals received.

The debug support interface ensures that the production device has the same behaviour as the development device. The development part has the same design as the production part, but with only the addition of passive components for transmission (lasers) and reception (diodes).

A second embodiment shown in FIG. 2 has optical sender cells 103 and optical receiver cells 110 integrated into the system integrated circuit 101 to form a monolithic circuit, so that connection to the optical sender cells 103 and receiver cells 110 is made using an integration process.

In this case, the difference between the mass production components and the development components is that the transmission link 107 is not connected for the mass production components.

A third embodiment shown in FIG. 3 has a translation mask 112 placed between the optical components 103,110 and the system integrated circuit 101. The translation mask or mask set provides a bonding pad arrangement having an inter pad spacing suitable for the attachment of optical sender cells 103 and optical receiver cells 110 on one side, and a bonding pad arrangement on the other side for the translation mask 112 to be bonded to the system integrated circuit 101. The translation mask 112 contains electrical connections 111 to link the bonding pad means on each side of the translation mask 112.

A fourth embodiment shown in FIG. 4 comprises electronic sender cells 113 and electronic receiver cells 118 connected using a suitable bonding means such as wire bonding 105. The electrical cells contain analogue circuits to implement digital communication with a greater bandwidth or data rate than a conventional port pin. These analogue circuits may be low swing voltage differential driver cells which are not conventionally integrated into predominantly digital, complementary metal oxide circuits.

The electrical cells connect to the external tool via connection structures 114 located above the system integrated circuit, and which provide a connection located on the surface of the device package 102.

A fifth embodiment as shown in FIG. 6 and FIG. 7 comprises a pad ring formed by the combination of the first arrangement of connection terminals 116 for system circuit use, combined with the second arrangement of connection terminals 117 for development use to form a ring of pads around the periphery of the system integrated circuit 101 together with the debug support circuits 100. The connection terminals 117 are then used to connect the bonding pads of external components 131 by wire bonding, FIG. 6 and FIG. 8 show only optical sender cells 103 connected by wire bonding.

A sixth embodiment as shown by FIG. 8 uses wire bonding to connect from the second arrangement of connection terminals 117 forming part of a pad ring to a further signal conversion arrangement 130 allowing construction using a different technology than the system integrated circuit 101. The further signal conversion arrangement 130 provides modulation and control of the optical sender cells 103.

In an alternative embodiment, the electronic sender cells 113 and electronic receiver cells 118 can be integrated onto the system integrated circuit 101. Bonding pads similar to the peripheral bonding pads 116 shown in FIG. 5 can then connect the high speed debug support interface to connection structures 114 above the system integrated circuit 101 providing a connection on the surface of the device package 102.

With reference to FIG. 5, the chip area adjacent to the perimeter of an integrated circuit is reserved for input and output bonding pads 116 to allow wire bonding 105 or similar to the device package bonding pads 115. This means that any bonding pads for the high speed optical connections must be located not at the chip perimeter.

One of many possible bonding schemes is the commercially used flip-chip bonding technique which uses solder bump technology 104 to join metal surfaces such as the top metal layers of two semiconductor devices or circuits.

As mentioned above, one suitable optical sender cell 103 is a vertical cavity surface emitting laser. This is a semiconductor diode laser that emits light from and normal to its substrate. An alternative optical sender means is self-electro-optic effect devices, which have the disadvantage of requiring an external bias light source. One suitable optical receiver cell 110 is a photo conductive diode. The optical signals to and or from the interface are transferred by guided waveform optics or by free-space optics or a hybrid combination of these two techniques as shown in FIG. 1.

In FIGS. 1 to 3, free space optics 106 are used to transfer the optical signals into and or out of the package 102 via an optically transparent window 109, external to the device package 102. These optical signals are transferred using guided waveform devices such as optical fibre cables or similar. An alternative is to use free-space optics externally to the device package 102; this requires additional optical components such as a light directing means depending on the chosen implementation method.

The use of optical signals to and/or from the device package is preferred over electronic signals as they are immune to electromagnetic interference. For all embodiments it is desirable for the connection means on the surface of the device package 102 to be detachable using a plug and socket, or clip or similar re-usable detachmnent means.

The high speed debug support interface with debug support circuits 100 communicates with the development tool 108 to provide a supportive infrastructure for advanced development techniques, including but not limited to tracing processor program counters, tracing data accesses and values, accesses to on-chip and or in-package memory and registers resources, external memory substitution for calibration or rapid prototyping or similar development activity. The high speed debug support interface contains a circuit to convert several low speed signals operating with a maximum of about 75 MHz to 100 MHz into fewer high speed signals operating in the approximate region of 800 MHz to 4 GHz or greater as technology advances. One example circuit is a time division multiplexing circuit that samples a fraction of the total bits of a low speed signal in one interface clock cycle and transmits them. In the next cycle, another fraction of bits will be transmitted, this will repeat until all the bits for the signal have been sent. As the high speed interface has a port and clock speed over one magnitude greater than the low speed signals the entire low speed signal can be transmitted in sequential parts within the duration of one clock cycle for the low speed circuits. This process can be reversed to form a means to convert one or several high speed signals into a greater number of low speed signals, thus de-multiplexing a time division multiplexed signal. Both these conversions may additionally include an encoding and decoding means for purposes such as error correcting, data compression or other coding purpose.

An alternative embodiment is to have more basic conversion circuits at the interface which arrange the internal signals into a format suitable for transmission from or distribution to the integrated circuit 101, adding error correction codes if required. These formatted signals are then directly connected to parallel sender cells 103 and parallel receiver cells 110 located on the surface of the integrated circuit 101. This approach is feasible as digital integrated circuits have an internal system clock speed of about 400 MHz or more, permitting direct connection with the high speed interface external connections. In this embodiment the number of fast connections is similar to the number of internal signals but despite reduced bandwidth per bit, increased bandwidth is still achieved by having many parallel connections. The signal conversion at the debug interface is then all electrical. This embodiment has the advantage that no external clock is required as the system clock is sufficient provided that the connection has many parallel bits.

The high speed interface circuits can be disabled, to leave a circuit with the same functionality as a conventional interface. This can be used for low cost development, as some applications are not real time and the developers do not then need fast tracing and can stop their systems or clock them slower. The interface can detect nearly full trace buffers and control the debug support circuits to gate/stop the clocks. In this way, the high speed debug support interface and debug support circuits of the invention can be controlled using conventional metal based port connections. This can also be used access debug support resources in a mass produced part not intended solely for development purposes. The mass produced part then has no optical or electrical connection with the surface of the system integrated circuit 101 other than through the conventional device and package connections formed via the bonding pads 116 at the perimeter of the system integrated circuit 101.

Thus, the high speed interface can be configured as a conventional interface, i.e. the high speed part can be disabled.

When the high speed debug support interface is not connected to high speed optical or electronic connections from the surface of the device package 102, it can be configured to use conventional connections to provide reduced development support functionality as part of a reduced functionality Mode. In both said reduced functionality mode and other modes the high speed debug support interface is able to access resources located within the package including separate integrated circuits placed within the device package 102 for use with the system and not explicitly for development purposes such as additional system memory accessible via the system interconnect. The high debug support interface and debug support circuits 100 may use the system interconnect to send debug support specific information as part of their internal operation or to interact with another interface or system component or resource.

Depending on the interconnect used by the system the high speed debug support interface will require circuits that can use on-chip and in-package packet switched networks and busses such as a network on-chip system interconnect.

There is a growing interest in placing DRAM or similar chips within the package of a microcontroller or system chip as part of the production device for use as extra system memory. However this is too expensive to be a realistic consideration for average systems. However, in low volume applications such as avionics and military, the cost is tolerable and there is thus interest in this system-in-package type device. The in-package arrangement of the memory device presents difficulties in monitoring the functioning of the memory device.

The debug support circuits can thus be used to access not only the system memory but also any additional extra memory device within the package. One advantage of providing in-package additional integrated circuits is that the in-chip/in-package connections are much faster than conventional package pins as they operate over a short distance and require less powerful drivers with lower capacitances.

In the examples described above, the debug support circuits are formed as part of the integrated circuit. Instead, they may be on separate substrates and be bonded to the main integrated circuit and thereby still forming part of the package. The debug interface can communicate with the debug support circuits either using dedicated on-chip interconnects, or by using the system interconnect. The system interconnect can be a conventional bus of hierarchy of busses, or a network on-chip or other in-package network. The high speed debug interface can include additional circuits to use a packet switched network for the efficient movement of debug support data.

Various modifications will be apparent to those skilled in the art.

1. An integrated circuit assembly for use in a system, comprising:
a first arrangement of connection terminals for connecting the integrated circuit to other components of the system;
debug circuitry;
a debug interface comprising a second arrangement of connection terminals;
a signal conversion arrangement coupled to the second arrangement of connection terminals for converting electrical signals provided to the second arrangement of terminals into a format for transmission to external monitoring circuitry; and
a communications link for communicating the data provided to the second arrangement of terminals to the external monitoring circuitry.

2. An assembly as claimed in claim 1, wherein the signal conversion arrangement comprises electro-optical conversion means, and the communications link comprises an optical communications link.

3. An assembly as claimed in claim 2, wherein the electro-optical conversion means comprises an array of lasers.

4. An assembly as claimed in claim 3, wherein the lasers comprise vertical cavity surface emitting lasers.

5. An assembly as claimed in claim 1, wherein the signal conversion arrangement comprises analogue electrical circuitry for implementing digital communication over the communications link.

6. An assembly as claimed in claim 1, wherein the signal conversion arrangement comprises analogue electrical circuitry for providing a control signal for controlling an electro-optical conversion means.

7. An assembly as claimed in any preceding claim, wherein the first arrangement of connection terminals are provided as a ring of terminals around the periphery of an upper surface of the assembly, and the second arrangement of connection terminals are provided on the upper surface of the assembly within the ring.

8. An assembly as claimed in claim 7, wherein the second arrangement of terminals are formed from a top metal layer of the assembly.

9. An assembly as claimed in any one of claims 1 to 6, wherein the first and second arrangements of connection terminals together define a ring of terminals around the periphery of an upper surface of the assembly.

10. An assembly as claimed in any preceding claim, further comprising a second integrated circuit memory device, comprising a third arrangement of connection terminals connected to the first or second arrangement of connection terminals of the first integrated circuit, wherein the debug interface provides access to internal operation information of the first and second integrated circuits.

11. A set of integrated circuits, comprising
at least one first integrated circuit assembly having debug capability and as claimed in any preceding claim; and
a plurality of second integrated circuit assemblies having the same design as the at least one first assembly in respect of the first arrangement of connection terminals and the debug interface, and wherein the plurality of second assemblies are not provided with the communications link of the at least one first assembly.

12. A set as claimed in claim 11, wherein the plurality of second integrated circuit assemblies have the same design as the at least one first assembly in respect of the debug circuitry, and wherein the plurality of second assemblies are also not provided with the signal conversion arrangement of the at least one first assembly.

13. A method of performing a debug operation, using an integrated circuit assembly comprising a first arrangement of connection terminals, debug circuitry, and a debug interface comprising a second arrangement of connection terminals, the method comprising:
coupling a signal conversion arrangement to the second arrangement of connection terminals;
using the signal conversion arrangement to convert electrical signals provided to the second arrangement of terminals into a second format;
transmitting the signals using the second format to external monitoring circuitry; and
performing a debug operation using the external monitoring circuitry.

14. A method as claimed in claim 13, wherein the second format comprises an optical transmission format and the signal conversion arrangement comprises electro-optical conversion means.

15. A method as claimed in claim 14, wherein the electro-optical conversion means comprises an array of lasers.

16. A method as claimed in claim 15, wherein the lasers comprises vertical cavity surface emitting lasers.

17. A method as claimed in claim 13, wherein the second format comprises a signal format for controlling an electro-optical conversion means.

18. An integrated circuit assembly for use in a system, comprising:
a first integrated circuit, comprising:
a first arrangement of connection terminals for connecting the integrated circuit to other components of the system;
debug circuitry;
a debug interface comprising a second arrangement of connection terminals; and
a second integrated circuit memory device, comprising:
a third arrangement of connection terminals connected to the first or second arrangement of connection terminals of the first integrated circuit,
wherein the debug interface provides access to internal operation information of the first and second integrated circuits.

19. An assembly as claimed in claim 18, wherein the first integrated circuit further comprises a signal conversion arrangement coupled to the second arrangement of connection terminals for converting electrical signals provided to the second arrangement of terminals into a format for transmission to external monitoring circuitry, and a communications link for communicating the data provided to the second arrangement of terminals to the external monitoring circuitry.

20. An assembly as claimed in claim 18, wherein the first integrated circuit further comprises a signal conversion arrangement coupled to the second arrangement of connection terminals for converting electrical signals provided to the second arrangement of terminals into a format for controlling an electro-optical conversion means for transmission to external monitoring circuitry, and an optical communications link for communicating the data provided to the second arrangement of terminals to the external monitoring circuitry.
